(19) United States
(12) Patent Application Publication
(10) Pub. No.: US 2007/0116438 A1
(43) Pub. Date: May 24, 2007

(54) Portable recording device

(76) Inventors: Scott Nyhart, Shawnee, KS (US); John Cross, Overland Park, KS (US); Jordan Vermillion, Overland Park, KS (US)

Correspondence Address: HOVEY WILLIAMS LLP, 2405 GRAND BLVD., SUITE 400, KANSAS CITY, MO, 64108, US

(21) Appl. No.: 11/283,626

(22) Filed: Nov. 21, 2005

(51) Int. Cl. H04N 7/12; H04N 7/26

(52) U.S. Cl. 386/112

(57) ABSTRACT

A portable recording device operable to receive an electrical signal input and convert the input to digital data is disclosed. The device broadly includes a portable handheld housing; a signal element operable to receive an electrical input signal; a controller operable to convert the input signal to digital data; a memory operable to store the digital data; and a power supply operable to power the device. Such an apparatus enables audio or digital image signals from a signal generating device to be conveniently converted into a desired digital format

### BACKGROUND OF THE INVENTION

1. Field of the Invention

The present invention relates to portable recording devices. More particularly, the invention relates to a portable recording device operable to receive an input and convert the input to digital data for storage.

2. Description of the Related Art

Electronic devices are increasingly utilized to capture and record still and moving images. For example, analog and digital camcorders, scopes, binoculars, telescopes, night-vision goggles, film and digital cameras, cellular phones, and innumerable other devices are operable to record still and moving images on a storage medium and/or output a signal corresponding to the recorded image.

Unfortunately, such beneficial functionality is often offset by the need to transport the often cumbersome signal generating devices to new locations, such as in proximity to a user's televison or home computer, for viewing or copying recorded images. Similarly, even when signal generating devices employ removable media, such as magnetic tape, the removable media must be also transported to a new location for copying, viewing, or access. Thus, sharing and copying of recorded images is limited by the need to transport devices and/or media for access and copying.

Additionally, signal generating devices often provide recorded images in analog signal formats that may not be easily ported between devices or manipulated by users. For example, various conventional devices such as video cameras are operable to output an analog video signal. However, such analog signals must be recorded or copied on cumbersome analog tapes for storage. Thus, use of analog signal generating devices is often limited due to the desire to organize and manipulate data in more manageable digital formats.

Furthermore, even when signal generating devices employ digital formats, users generally must utilize full-function computers to retrieve and store outputted digital video signals. As signal generating devices may not always be in proximity to full-function computers, the ability to store signals for later access, viewing, or copying, is therefore often limited.

### SUMMARY OF THE INVENTION

The present invention solves the above-described problems and provides a distinct advance in the art of portable recoding devices. More particularly, the invention provides a portable recording device operable to receive an input and convert the input to digital data for storage in a digital format. Such an apparatus enables audio or digital image signals from a signal generating device to be conveniently converted into a desired digital format without requiring unnecessary transportation of the signal generating device.

In one embodiment, the recording device broadly includes a portable handheld housing; a signal input element housed at least partially within the housing and operable to receive an electrical input signal representing an image; a controller housed within the housing and coupled with the input element, the controller operable to convert the input signal to digital data; a memory housed at least partially within the housing and coupled with the controller to store the digital data; and a power supply positioned-at least partially within the housing and operable to power the device. The device is operable to receive and convert both digital and analog signals.

In another embodiment, the recording device includes a portable handheld housing; a signal input element housed at least partially within the housing and operable to receive an analog video signal; a controller housed within the housing and coupled with the input element; a removable memory housed at least partially within the housing and coupled with the controller to store digital data; and a power supply positioned at least partially within the housing and operable to power the device. The controller includes a video decoder operable to convert the analog video signal to digital data.

In another embodiment, the recording device includes a portable handheld housing; a signal input element housed at least partially within the housing and operable to receive an analog video signal; a controller housed within the housing and coupled with the input element; a memory housed at least partially within the housing and coupled with the controller to store digital data; and a power supply positioned at least partially within the housing and operable to power the device. The controller generally comprises a video decoder operable to convert the analog video signal to digital data and a processor coupled with the video decoder and operable to compress the digital data. The memory preferably includes a memory slot operable to receive a removable memory card.

The device may further include a control input element coupled with the controller and operable to control the conversion of the analog video signal to digital data and a display coupled with the housing and the controller and operable to display the digital data.

Other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is a front perspective view of a portable recording device configured in accordance with various embodiments of the present invention;

FIG. 2 is a rear perspective view of the recording device of FIG. 1;

FIG. 3 is a plan view of the recording device of FIGS. 1-2 shown coupled with a signal generating device;

FIG. 4 is a front perspective view of another portable recording device configured in accordance with various embodiments of the present invention; and

FIG. 5 is a block diagram illustrating various elements of the recording devices of FIGS. 1-4.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

Reference will now be made in detail to various preferred embodiments of the present invention, examples of which are illustrated in the accompanying drawings. Wherever possible, the same reference numbers are used throughout the drawings to refer to the same or like parts.

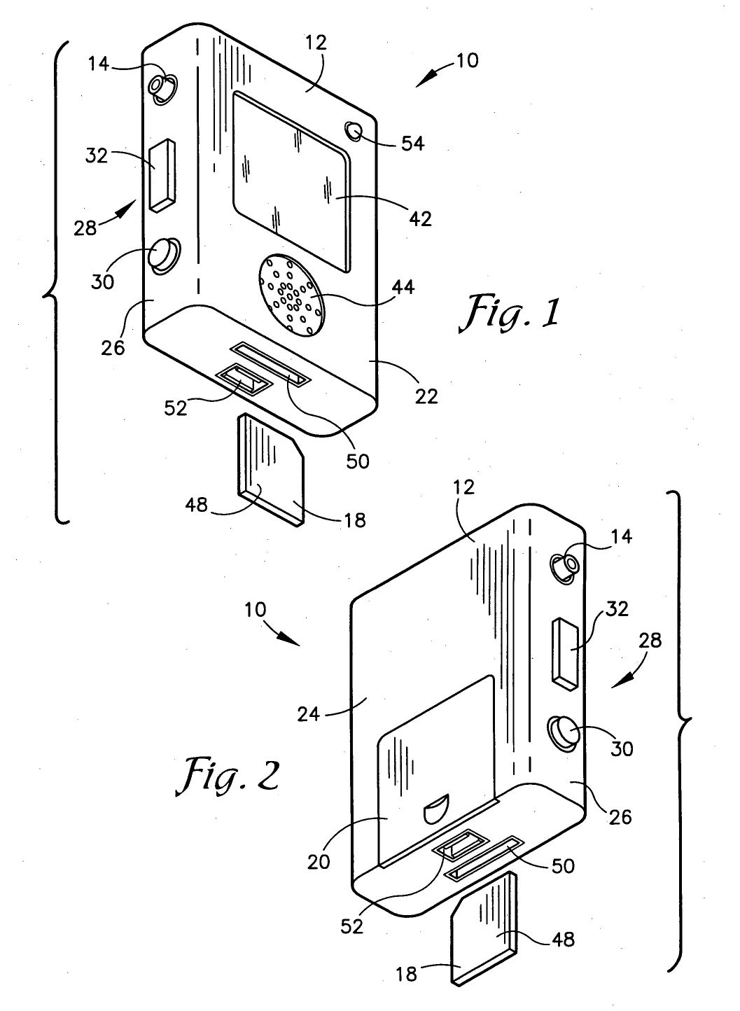

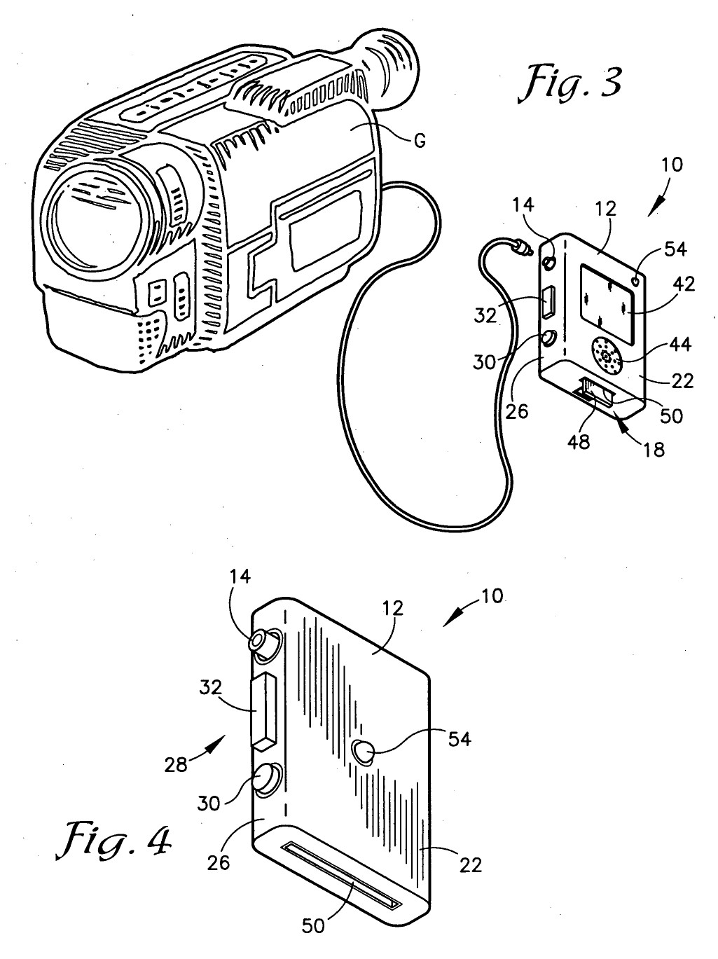

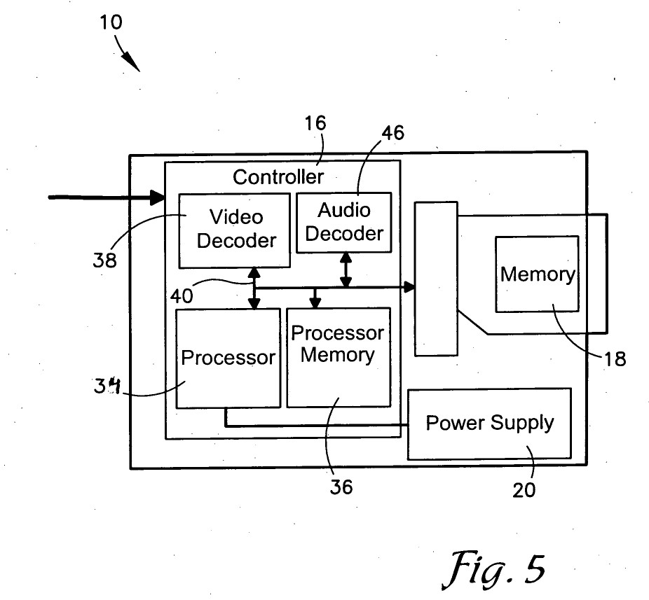

Referring to FIGS. 1-5, a recording device 10 is shown constructed in accordance with various preferred embodiments of the present invention. As is described below in more detail, the device 10 is operable to be coupled with a signal generating device G to convert generated image or video signals into digital data in a desired digital format.

The device 10 broadly includes a portable handheld housing 12, a signal input element 14 coupled with the housing 12 and operable to receive a electrical signal from the signal generating device G; a controller 16 housed within the housing 12 and operable to convert the input signal to digital data; a memory 18 housed at least partially within the housing 12 and operable to store the digital data; and a power supply 20 operable to power the device 10.

The housing 12 is sized and configured to be portable and handheld such that the device 10 may be easily transported and utilized in numerous indoor and outdoor environments. For example, the housing 12 may be wallet sized, credit card sized, key-chain sized, etc, to facilitate transport, use, and storage. As is discussed below, various elements of the device 10 may be omitted to reduce the size of the housing 12 and complexity of the device 10 to further facilitate transport, use, and storage of the device 10.

The housing 12 is preferably comprised of substantially resilient material to enable the device 10 to be utilized in inclement environmental conditions such as rain, snow, and other related weather. For example, the housing 12 may be formed from ABS, other plastics, metals, or any other resilient materials. Additionally, the housing 12 is preferably substantially waterproof such as by satisfying or exceeding the IPX7 waterproof standard.

The housing 12 generally includes a front 22, a rear 24, and sides 26 preferably arranged in a generally rectangular configuration. The housing 12 may further include various cavities, slots, protrusions, holes, etc, to enable the coupling of various elements within, on, and/or through the housing 12, such as the signal input element 14. Furthermore, the housing 12 may include coupling elements such as a clip or belt strap for coupling with a user during transport.

The signal input element 14 is housed at least partially within the housing 12 and is operable to receive an electrical input signal from the signal generating device G. The input signal preferably represents an image, such as a digital or analog video or still image signal. For example, the input signal may be a VGA, NTSC, PAL, SECAM, s-video, composite video, etc, signal representing video or a still image. Similarly, the input signal may be a digital signal such as a data stream including video and audio data in various digital formats, such as ASTC, DVB, and ISDB, and/or a data stream provided by a network connection, such as data received from the internet, a LAN, etc. Furthermore, the input signal may include both video data and audio data, such as an analog video signal including both moving images and accompanying sounds.

Thus, the signal input element 14 may receive any form of input signal, digital or analog, from the signal generating device G. As a result, the signal generating device G may include various devices such as computers, televisions, consumer electronics such as cable decoders, DVD players, DVRs, VCRs, etc, video recorders such as analog and digital camcorders, scopes, binoculars, telescopes, night-vision goggles, film and digital cameras, combinations thereof, or any device operable to generate an input signal representing a video or still image.

The signal input element 14 may wired or wirelessly couple with the signal generating device G to receive the input signal. Preferably, the signal input element 14 includes a conventional RCA female input jack, or a ⅛″ phono jack, for receiving a video or s-video cable coupled with the signal generating device G. Such a configuration may be desirable as it enables the device 10 to be utilized with numerous conventional signal generating devices that commonly include RCA or s-video outputs.

However, the signal input element 14 may include other or additional elements for coupling with the signal generating device G, such as CAT5, RJ45, ethernet, fiber-optic, infrared, WiFi, Wi-Max, radio-frequency, ultra-wideband, modem, etc, elements for wired or wirelessly receiving the input signal from the signal generating device G.

The controller 16 is housed within the housing 12 and coupled with the input element 14 to convert the input signal to digital data. Specifically, the controller 16 may identify the form of the input signal, such as analog, digital, NTSC, etc, utilize known algorithms to decode and convert the input signal to digital data, and process to the digital data to provide the digital data in a desired format.

Thus, regardless of the form or format of the input signal, the controller 16 is operable to convert the input signal to digital data for additional processing or storage. Additionally, the controller 16 may be operable to auto-detect and auto-convert the input signal such that a user need not specifically dictate or otherwise control the operation of the device 10 and/or controller 16. For instance, upon reception of the input signal by the signal input element 14, the controller 16 may automatically convert the input signal to digital data without requiring additional user input or control.

However, the device 10 preferably additionally includes a control input element 28 coupled with the controller 16 and operable to control the conversion of the input signal to digital data. The control input element 28 preferably comprises one or more functionable inputs associated with the housing 12 to enable the user to function the inputs to control the operation of the controller 16. Preferably, the control input element 28 includes switch 30 and a trigger 32 associated with one side 26 of the housing 12. As is described below, the switch 30 and trigger 32 may be utilized to select various modes of operation for the controller 16.

In situations where the input signal is an analog signal, the controller 16 may convert the input analog signal to digital data including a digital video file and/or a digital image file. For example, an analog NTSC input signal from the signal generating device G may be converted to a .MOV (QUICKTIME motion JPEG) digital data file, or digital image file such as a bitmap or JPEG. As will be appreciated by those skilled in the art, conversion of the input signal is not limited to these particular formats, as the controller 16 may be operable to convert input signals into various formats, including but not limited to: MOV, MPEG, GIF, BMP, JPEG, RM, AVI, etc. Furthermore, the controller 16 may convert the input signal to one or more of these formats based upon inputs provided by the control input element 28.

In situations where the input signal is a digital signal, the controller 16 may similarly convert the input signal to a digital video file and/or a digital image file in one or more of the formats discussed above. Such conversion of a digital input signal to digital data may be desirable to enable a user to easily copy signals provided by the signal generating device G without being required to transport or otherwise maneuver the signal generating device G to a new location, such as in proximity to a home computer or other conventional computing device, for copying.

Preferably the controller 16 includes a processor 34, a processor memory 36, and a video decoder 38 to facilitate conversion of the input signal to digital data. The video decoder 38 is coupled with the signal input element 14 through a data bus 40 or other similar element to receive the input signal. The video decoder 38 is preferably operable to detect the form of the input signal and convert the input signal to digital data.

In various embodiments, the video decoder 38 may be BT829 videostream decoder or equivalent. In such embodiments, the video decoder 38 is operable to convert the input signal, such as an analog video signal, to digital data representing a YCrCb 4:2:2 data stream, unfiltered 8*Fsc data, or other digital data formats. The converted digital data provided by the video decoder 38 may be stored in the memory 18 without further processing such that utilization of the processor 34 and processor memory 36 need not be necessary in all embodiments.

Preferably, the processor 34 and/or processor memory 36 are coupled with the video decoder 38 through the data bus 40, such as an I²C interface, to receive the converted digital data. For example, the processor 34 may be coupled with the video decoder 38 and control input element 28 to control operation of the video decoder 38 based on user inputs and to receive the converted YCrCb 4:2:2 or similar data.

The processor 34 may process the data received from the video decoder 38 to facilitate storage and use of the converted data such as by receiving the data provided by the video decoder 38 and converting, compressing, processing, or otherwise forming the data into a desired digital format. For example, the processor 34 may convert the YCrCb 4:2:2 data into a digital video file, such as a MOV file, or digital image file, such as a JPEG, as described above. Such functionality is generally desirable at it enables converted data provided by the video decoder 38 to consume less memory due to compression and to be stored in a format more accessible to users.

The processor 34 may comprise conventional microprocessors, microcontrollers, programmable logic devices, or other logic elements operable to perform the functions described herein. Those skilled in the art will appreciate that it is desirable to utilize logic elements having processing power sufficient to quickly process, convert, compress, and/or form data without interfering with the use of the device 10. For example, the conversion of analog video data to a compressed digital video file or image often requires the execution of complex algorithms that demand significant processing power. Thus, the processor 34 preferably includes a microprocessor, such as a SHARP ARM 7 processor.

The processor memory 36 is preferably coupled with the processor 34 and/or the video decoder 38 through the data bus 40. However, the processor memory 36 may be integral with the processor 34, such as in embodiments where in the processor memory 36 is on-board cache memory. The processor memory 36 enables the storage of uncompressed or intermediate data utilized by the processor 34 to facilitate the functionality thereof. For example, the processor memory 36 may temporarily store digital data provided by the video decoder 38, such as the YCrCb 4:2:2 data, to enable the processor 34 to quickly access the data for formatting.

Similarly, the processor memory 36 may operable as a cache memory for storing data before transfer to the memory 18 to facilitate rapid transfer of data from the signal generating device G and the device 10. For example, the processor 34 may cache digital image data, such as a bitmap image, in the processor memory 36, to enable the processor 34 to later convert the cached digital image to a compressed digital image such as a JPEG. Additionally, the processor memory 36 is preferably operable to store one or more code segments for instructing the controller 16 and/or processor 34 to control the device 10.

As such, the processor memory 36 preferably includes non-removable quick access components, such as SRAM and flash memory. However, the processor memory 36 may include other memory elements, such as PROMs or EPROMs. Similarly, the various intermediate data and code segments discussed above may be stored throughout various mediums included within the processor memory 36.

The device 10 may additionally include a display 42 coupled with the housing 12 and the controller 16. The display 42 is operable to display various information relating to the device 10, including the status of the device 10 and/or data received and/or converted by the device 10 and controller 16. For example, the display 42 may include a LCD display coupled with the exterior of the housing 12 and the controller 16 to indicate the status of the device 10, such as the mode of operation of the device 10, the power status of the device 10, the storage space available in the memory 18, the name or listing of all data stored within the memory 18, the status of any conversion or data transfer to and from the device 10, etc.

The display 42 may additionally or alternatively include a color display, such as a color QVGA or similar display. In such embodiments, the display 42 may display converted video data in addition to the status information discussed above. For example, the display 42 may display the input signal received by the device 10 in real time to enable a user to determine if the signal is suitable for conversion, as described below. Additionally, the display 42 may display the converted data stored within the memory 18, or data otherwise processed by the controller 16, for playback or confirmation by the user. For instance, the display 42 may display an input analog video signal to enable a user to function the control input element 28 for conversion and then also, at a later time, enable the user to view any converted or otherwise stored digital data. Similarly, the display 42 enables the user to view data during conversion to ensure appropriate operation of the device 10.

To enable the display of converted digital data on the display 42, the processor 34 is operable to retrieve digital data from the memory 18 and process the retrieved data into the appropriate format for display. For example, the processor 34 may retrieve a digital video file stored within the memory 18 and process the digital video file to provide data in an appropriate format for display.

The device 10 may additionally include a speaker 44 to output audio data provided by the input signal and/or input data stored within the memory 18 or otherwise processed by the controller 16. The speaker 44 is a generally conventional speaker and is preferably housed within a cavity of the housing 12 and coupled with the controller 16 for reception of audio signals. The speaker 44 is preferably operable to generate real-time sound corresponding to the input signal and also corresponding to the playback of any recorded or otherwise processed data.

The controller 16 may additionally include an audio decoder 46 operable to convert audio signals provided by the signal generating device G and/or other controller 16 elements, such as the video decoder 38. For example, the input signal provided by the signal generating device G to the device 10 may include video and audio data, or only video or audio data. As such, the video decoder 38 is operable to convert the input signal to provide digital data including both video and audio data. However, in various situations it may be desirable to use the discrete audio decoder 46 to process the audio data provided by the input signal and/or video decoder 38 to reduce consumption of controller 16 and processor 34 resources. For example, the audio decoder 46 may enable the device 10 to play and/or record MP3 audio data without consuming processor 34 resources.

The controller 16 may additionally be operable to perform conventional computing functions, such copying, naming, organizing, and otherwise controlling data stored within the device 10. Similarly, the controller 16 may additionally be operable to control external devices, such as the signal generating device G, that are coupled with the device 10 to facilitate copy and conversion of data.

The memory 18 is coupled with the controller 16 and is operable to store digital data, such as data converted or otherwise processed by the controller 16. The memory 18 is operable for storage of data even when the device 10 is not powered to enable generally permanent storage of data. Thus, the memory 18 may include various conceptional computer readable mediums and memories, such as electronic, magnetic, optical, and related mediums.

Preferably, the memory 18 is removable, such as removable memory card 48 operable for reception in a memory slot 50 formed on the housing 12. The removable memory card 48 may comprise conventional and commonly utilized portable memory formats including Secure Digital, Compact Flash, etc. Such a configuration is desirable as it enables stored data to be easily transported and utilized in various conventional devices, including home computers.

Furthermore, it will be appreciated by those skilled in the art that it is desirable for the memory 18 to include a capacity sufficient to store converted data, such as a plurality of digital video and image files. Thus, the memory 18, such as the memory card 48, preferably includes a capacity of at least 1 GB to enable the storage of multiple and/or lengthy files. However, lesser storage capacities may also be used in embodiments where lesser storage capacity is acceptable.

The power supply 20 is operable to power the device 10 and related components. The power supply 20 may include any conventional powering elements, including rechargeable and non-rechargeable and removable and non-removable battery elements. Due to the efficient operation of the device 10, the power supply 20 is preferably operable to provide power utilizing conventional AA batteries.

The device 10 may additionally include a USB port 52 or similar connecting device for coupling with one or more conventional computing devices or similar or identical portable recording devices. For example, the device 10 may be coupled to a computing device, such as a home computer, through the USB port 52 to enable the computing device to access the memory 18 to transmit and receives data therefrom. Also, the USB port 52 may be integral with the memory 18 such that a USB flash drive, or similar USB memory element, may be inserted into the USB port 52 to enable the storage of converted data thereon, thereby eliminating the need for the memory card slot 50.

The device 10 also may be configured to include a status indicator 54, instead of or in addition to the display 42, to indicate the status of the device 10. Preferably, the status indicator 54 comprises one or more LEDs operable to display various colors, such as red, green, any yellow, to correspond to various states and modes of operation of the device 10.

As shown in FIG. 4, the device 10 may lack many of the features described above to reduce size, power consumption, complexity, related cost, etc. For example, the device 10 may lack the display 42 and speaker 44 to reduce the size of the housing 12 to decrease cost and complexity and further increase the portability of the device 10. Such a configuration enables the housing 12 to be compactly configured, such that the housing 12 may be similar in size to the memory 18, thereby providing a more compact and easily transportable device. Similarly, in various embodiments other features of the device 10 may not be included to further reduce the size and complexity of the device 10, such as the control input element 28, processor memory 36, audio decoder 46, USB port 52, status indicator 54, etc.

In operation, a user may easily transport the device 10 to the location of the signal generating device G due to the compact configuration of the housing 12. To activate the device 10 for use, the user may function the control input element 28, such as by depressing the switch 30, or the in various embodiments the device may auto-activate upon receiving the input signal as discussed below. Upon activation, the status indicator 54 may indicate “green” and/or the display 42 may indicate activation of the device 10.

The user couples the device 10 with the signal generating device through the input element 14 utilizing a wired or wireless connection as described above. In embodiments wherein the memory 18 is removable, the user may also insert the removable memory card 48 into the slot 50 to enable data storage or transfer.

To control the conversion of the input signal to digital data, the user may function the control input element 28. For example, the user may depress the switch 30 to select the operational mode of the device 10. The device 10 broadly includes three modes of operation: single frame capture mode; fixed length video mode; and continuous run video loop mode.

In the single frame capture mode, the user may function the control input element 28, preferably by depressing the trigger 32, to capture a single frame of the input signal. For example, in embodiments wherein the input signal is an analog video signal, the user may view the input signal on the display 42 or on the signal generating device G, and then depress the trigger 32 to capture a single frame of the input signal to convert the input signal to a digital image file. Each depression of the trigger 32 therefore converts a single frame of the input signal to a digital image file.

In the fixed length video mode, the user may function the control input element 28, preferably the trigger 32, to convert the input signal to digital data, and preferably a digital video file, until a predetermined video length is satisfied or until the capacity of the memory 18 is exceed. The user may set the predetermined video length by functioning the control input element 28 and/or the predetermined video length may be configured during manufacture. Thus, the user may view the input signal on the display 42 and function the trigger to convert the input signal to a digital video file having a length corresponding to the predetermined video length. For instance, the user may depress the trigger to record the next one minute of the input signal into digital data.

In the continuous run video mode, the user may function the control input element 28, preferably the trigger 32, to convert the input signal to digital data, preferably a digital video file, by indicating a start position and an end position for converting data. For example, the user may function the trigger 32 to start conversion of the input signal to digital data and then function the trigger 32 again to end conversion of the input signal.

Alternatively, the user may function the trigger 32 to start continuous conversion of the input signal based upon a predetermined loop length. For example, the user may set the loop length to be one minute, such that after depressing the trigger 32 video is converted and stored in one minute loops based upon the loop length or depression of the trigger 32. Each loop may be stored in a separate digital file, such as a digital video file, or the device 10 may rewrite the loop after each period such that only the last loop period is stored within the memory 18. Such a configuration may be desirable as it enables the user to continuously convert data, and then function the control input element 28 to store the last minute, or other set interval, of data.

After conversion and storage of data, the user may function the control input element 28 to manipulate the converted data, such as by copying, naming, and organizing data stored within the memory 18. Similarly, the user may function the control input element 28 to display stored data on the display 42 as described above.

In various embodiments, the user may also remove the removable memory 18 to transport the converted data to different devices for use. For example, the user may remove the memory card 48 to transport the converted data to a home computer, etc.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A recoding device including:
a portable handheld housing;
a signal input element housed at least partially within the housing and operable to receive an electrical input signal representing an image;
a controller housed within the housing and coupled with the input element, the controller operable to convert the input signal to digital data;
a memory housed at least partially within the housing and coupled with the controller to store the digital data; and
a power supply positioned at least partially within the housing and operable to power the device.

2. The device of claim 1, wherein the input signal is an analog signal and the controller converts the analog signal to digital data.

3. The device of claim 2, wherein the input signal is an analog video signal and the controller converts the analog video signal to a digital video file.

4. The device of claim 2, wherein the input signal is an analog video signal and the controller converts the analog video signal to a digital image file.

5. The device of claim 1, wherein the input signal is a digital video signal and the controller converts the digital video signal to a digital video file.

6. The device of claim 5, wherein the input signal is a digital video signal and the controller converts the digital video signal to a digital image file.

7. The controller of claim 1, wherein the controller includes a processor, a video decoder, and processor memory.

8. The controller of claim 1, wherein the memory is removable.

9. A recoding device including:
a portable handheld housing;
a signal input element housed at least partially within the housing and operable to receive an analog video signal;
a controller housed within the housing and coupled with the input element, the controller including a video decoder operable to convert the analog video signal to digital data;
a memory housed at least partially within the housing and coupled with the controller to store the digital data; and
a power supply positioned at least partially within the housing and operable to power the device.

10. The device of claim 9, wherein the controller further includes a processor and processor memory to facilitate conversion of the analog video signal to digital data.

11. The device of claim 9, wherein the controller converts the analog video signal to a digital video file.

12. The device of claim 11, wherein the controller continuously converts the analog video signal to a digital video file.

13. The device of claim 9, wherein the controller converts the analog video signal to a digital image file.

14. The controller of claim 9, wherein the memory is removable.

15. A recoding device including:
a portable handheld housing;
an signal input element housed at least partially within the housing and operable to receive an analog video signal;
a controller housed within the housing and coupled with the input element, the controller comprising—
a video decoder operable to convert the analog video signal to digital data, and
a processor coupled with the video decoder and operable to compress the digital data;
a memory slot housed at least partially within the housing and coupled with the controller, the memory slot being operable to receive a removable memory card to store the compressed digital data;
a control input element coupled with the controller and operable to control the conversion of the analog video signal to digital data;
a display coupled with the housing and the controller and operable to display the digital data; and
a power supply positioned at least partially within the housing and operable to power the device.

16. The device of claim 15, wherein the analog video signal includes video and audio data and the digital data includes corresponding digital video and digital audio data.

17. The device of claim 15, wherein the controller converts the analog video signal to a digital video file.

18. The device of claim 17, wherein the controller continuously converts the analog video signal to a digital video file.

19. The device of claim 15, wherein the controller converts the analog video signal to a digital image file.

20. The device of claim 15, wherein controller further includes processor memory coupled with the processor to facilitate compression of the digital data.
